(19) United States
(12) Patent Application Publication
(10) Pub. No.: US 2011/0274011 A1
(43) Pub. Date: Nov. 10, 2011

(54) Method and Device for Data Service Provisioning

(76) Inventors: Martin Stuempert, Hochspeyer (DE); Joerg Christian Ewert, Aachen (DE)

(21) Appl. No.: 13/142,522

(22) PCT Filed: Dec. 29, 2009
(86) PCT No.: PCT/EP09/09289

§ 371 Date: Jul. 30, 2011

(30) Foreign Application Priority Data
Dec. 29, 2008 (DE) 202008017174.1

(51) Int. Cl. H04W 28/18; H04W 48/18

(52) U.S. Cl. 370/259

(57) ABSTRACT

The invention refers to a method for supporting a data service provisioning, a device adapted thereto, and a corresponding computer program product. The method comprises the steps of receiving a service request for the data service, receiving a time range requirement in relation to the requested data service, wherein said time range requirement indicates a time range, in which the requested data service is to be provided, and selecting an access network that can provide the data service in the given time range.

The invention refers generally to a data service provision in a communication system. It is in particular useful for non real time data synchronization, and for users that seek to pay what they want for a service.

### BACKGROUND

Today there exist many complementing wireless broadband technologies (e.g. WLAN, GPRS and UMTS). All these accesses provide real time broadband connectivity to the user. The user has to pay a certain fee, which is charged per time or volume.

So-called Quality of Service Brokers are known, which select an appropriate access network for actual service provision. The selection is performed for a current communication demand under consideration of quality of service (QoS) requirements and costs.

If a service request cannot be fulfilled at present, it is rejected. Alternatively, a service request might be fulfilled at present under less favorable conditions with respect to quality of service or costs, even if it is not time critical, when the service provisioning starts at all.

Therefore, there is a need for a more flexible system for data service provisioning.

### SUMMARY OF THE INVENTION

It is an object of the invention to provide means for flexible data service provisioning.

This object is solved by teaching of the independent claims.

Further preferred embodiments are given in the dependent claims.

The invention refers to a device adapted to perform a method for supporting a data service provisioning comprising the steps of receiving a service request for the data service, receiving a time range requirement in relation to the requested data service, said time range requirement indicating a time range, in which the requested data service is to be provided, and selecting an access network that can provide the data service in the given time range.

Preferably, the device comprises means for receiving a service request for the data service, like a receiver or a network interface, means for receiving a time range requirement in relation to the requested data service, like the same or a different receiver or network interface, and means for selecting an access network that can provide the data service in the given time range, like a processor or a processor connected to a memory or database. The means for selecting can optionally include one or more interfaces to other data sources or network elements that are asked for or that provide information relevant to the selection (like location information, terminal capabilities, access coverage information or others).

The given means are coupled, e.g. via at least one device-internal bus or via dedicated connections.

Optionally, the device is adapted to perform the steps of receiving a quality of service requirement in relation to the requested data service, said quality of service requirement indicating a required quality of service of the requested data service, and selecting an access network that can provide the data service while fulfilling the required quality of service.

Preferably, the device comprises means for receiving a quality of service requirement in relation to the requested data service, and means for selecting an access network that can provide the data service while fulfilling the required quality of service.

Optionally, the device is adapted to perform the steps of receiving a cost requirement in relation to the requested data service, said cost requirement indicating an upper cost limit or a price offer for the requested data service, and selecting an access network that can provide the data service while fulfilling the cost requirement.

Preferably, the device comprises means for receiving a cost requirement in relation to the requested data service, and means for selecting an access network that can provide the data service while fulfilling the cost requirement.

Optionally, the data service is a synchronization of data of an email account with a user device.

Optionally, the data service is an internet access.

Optionally, the service request originates from a user, and the device is adapted to perform the step of sending an acceptance message to the user that the service request is accepted.

Preferably, the device comprises means for sending an acceptance message to the user that the service request is accepted.

Optionally, the service request originates from a user, and the device is adapted to send a service confirmation message indicating that a provision of the requested data service is possible at present.

Preferably, the device comprises means for sending a service confirmation message indicating that a provision of the requested data service is possible at present.

Optionally, the service request originates from a user, and the device is adapted to perform the step of sending a password to the user, said password being required to access the requested data service.

Preferably, the device comprises means for sending a password to the user, said password being required to access the requested data service.

Optionally, the service request originates from a user, and the device is adapted to perform the one-time or repeated step of determining an availability of at least one access network, which the user is allowed to access, wherein the access network is selected only from those access networks that are determined to be available for the user.

Preferably, the device comprises means for determining an availability of at least one access network, which the user is allowed to access.

Optionally, the service request originates from a user, and the device is adapted to perform the one-time steps or repeated steps of determining a location of the user and of determining, whether an access network is present at the determined location, wherein an access network that is not present at the location is not selected.

Preferably, the device comprises means for determining a location of the user and for determining, whether an access network is present at the determined location.

Optionally, the device is adapted to perform the one-time or repeated step of negotiating with at least one access network a fee for the data service.

Preferably, the device comprises means for negotiating with at least one access network a fee for the data service.

Optionally, the device is adapted to perform the step of determining for at least one access network by a look-up table comprising time information in relation to charging information of access networks, whether the service can be provided at a service fee not higher than the upper cost limit or the price offer.

Preferably, the device comprises means for determining for at least one access network by a look-up table comprising time information in relation to charging information of access networks, whether the service can be provided at a service fee not higher than the upper cost limit or the price offer.

Optionally, the device is adapted to perform the one-time steps or repeated steps of polling available access networks and requesting the data service as a best effort service, and of determining which of the polled access networks can provide the data service at first.

Preferably, the device comprises means for polling available access networks and requesting the data service as a best effort service, and for determining which of the polled access networks can provide the data service at first.

Optionally, the device is adapted to perform the one-time steps or repeated steps of broadcasting a request to access networks for the data service to be provided as a best effort service, and of determining which access network can provide the data service at first.

Preferably, the device comprises means for broadcasting a request to access networks for the data service to be provided as a best effort service, and for determining which access network can provide the data service at first.

Optionally, the device is adapted to perform the steps of receiving capacity information comprising information about unused bandwidth, from at least one access network, storing or updating said capacity information in relation to the corresponding access network, and the device is adapted to select an access network by using the stored or updated capacity information.

Preferably, the device comprises means for receiving capacity information comprising information about unused bandwidth, from at least one access network, means for storing or updating said capacity information in relation to the corresponding access network, and means for selecting an access network by using the stored or updated capacity information.

Optionally, the device is adapted to perform the one-time step or the repeated step of signalling to a user device that no new emails are available, unless an access network is selected.

Preferably, the device comprises means for signalling to a user device that no new emails are available, unless an access network is selected.

Preferably, the time range identifies a dedicated time period in the future.

Preferably, the time range requirement comprises at least one of a start time of the time range or an end time of the time range.

Preferably, the time range requirement comprises a duration of the time range.

Preferably, the start time identifies a start time in the future.

Preferably, the device comprises at least one of a service centre of a communications network, a switching node, a proxy node, a radio access node, a node of an Intelligent Network or a Wireless LAN device or a WIMAX device, or a mobile terminal.

The invention refers to a corresponding method and to a corresponding computer program.

### BRIEF DESCRIPTION OF THE FIGURES

The invention is explained with reference to the following figures, which show:

FIG. 1a a traffic profile over a timeline of an email server,

FIG. 1b access coverage areas during a travel over the said time line,

FIG. 2 an embodiment of the invention for user-transparent handling of excess-capacity,

FIG. 3 an embodiment of a structure of the device according to the invention,

FIG. 4 an embodiment of a method flow for supporting data service provisioning performed by the device,

FIG. 5 an embodiment of a method flow for supporting data service provisioning performed by the device,

FIG. 6 an embodiment of a method flow for selecting an access network performed by the device, and

FIG. 7 a further embodiment of the device according to the invention.

### DETAILED DESCRIPTION

A particular use case for the invention is described in the following.

A particular concern for a business traveler is the synchronization of the email account. For some of business travelers it might be acceptable that their emails are synchronized once or twice during the day. When this happens is not important as long it happens. In other words, bandwidth of an access network of a communication system is not needed at a certain point of time, but instead it is sufficient that the bandwidth is available at some point during a certain time range.

There might be bandwidth available in the network, which is not used during low-traffic time or due to pricing etc. The invention allows for improving the use of such spare capacity by a more flexible data service provision.

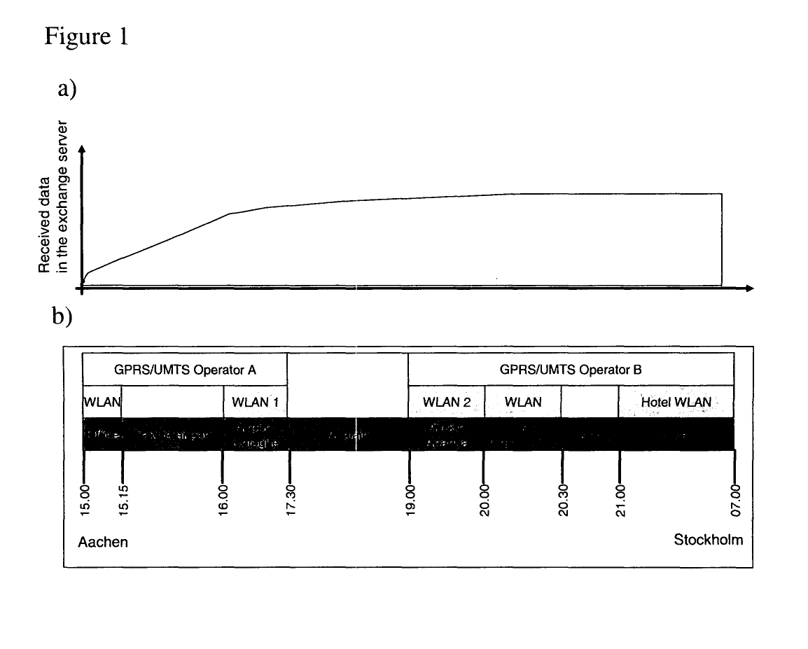

Referring to FIG. 1: A business traveler, which is a subscriber to one or more subscriptions, e.g. from different operators, offering data service provisioning travels from Aachen to Stockholm. During the journey he will pass as shown in FIG. 1b areas were he has GPRS or UMTS coverage and WLAN hotspot coverage. Coverage is provided by different operators. There are some time periods without any coverage, e.g. in the airplane. It is important for him that in the morning the data of the notebook is synchronized with the email server (e.g. an Exchange Server), which can be situated in a cooperate intranet. It is not important for him, when this exactly happens and which particular provider is used, in particular because the email server receives anyhow all the time emails for said business traveler, as shown in FIG. 1a.

According to the invention, the subscriber can request a best effort service from a service center. A best effort service means here a service, which can effort a delay of several hours, e.g. the synchronization with an email server. The service center optionally checks the location of the requesting subscriber (called user as well in the following), and it negotiates with different accesses if the request can be granted based on unused bandwidth. In a particular embodiment, the service center has a mapping table between access and location.

In a further embodiment, the service center polls the accesses with a service request. The accesses may locate the subscriber. The first responsive access, which has more than the needed bandwidth available, will become the access provider for the requested service.

Referring to an embodiment illustrated by a travel scenario: The user has a subscription to a service centre. The customer requests from said service centre that he would like to synchronize data during a certain duration, e.g. between 25.05.08 3 pm and 26.05.08 7 am, e.g. as a subscription. The user enters a fee and accepts that he has to pay that fee. The fee can be a flat rate for the request, or it can be indicated per time or per bandwidth. The access provider has the possibility to offer a lower price than a regular fee, because the user will not be able to determine the point of time, when the bandwidth will be available, therefore when the access will be granted.

The service centre can issue a location reporting request to the subscriber. Responsive thereto, the subscriber, respectively his terminal, responds with available accesses at the present location. Alternatively, the response can comprise location information, e.g. GPS coordinates. In a further embodiment, the service center can get the position information of a subscriber from a location based system maintained by an operator of a communication system, where the subscriber is subscribed to. Based on a location information, the service centre determines the available accesses, e.g. via a look-up table.

As a result, the service centre knows which accesses (e.g. GSM, UMTS, WLAN) are available in the particular location area of the subscriber. The service centre negotiates with the different accesses, or their operators respectively, if in the predetermined range, e.g. in the next hours excess bandwidth is available and for which price.

If the price fits the expectations of the subscriber, which e.g. can be specified in a subscriber profile in the service centre or which can be specified in an individual service request issued by the subscriber, the service center will send a message towards the subscriber, i.e. to his device, e.g. via Short Message Service SMS or via a signaling channel, confirming the granted access. Said message can include login information (e.g. password, one-time-password). The subscriber-device connects in response thereto towards the WLAN hotspot, and synchronizes the data.

In a further embodiment, the service centre is belonging to an operator and only one access is provided (e.g. GPRS but no WLAN). Even in such a limited configuration the operator can use excess capacity in his network (here GPRS network) at low traffic hours.

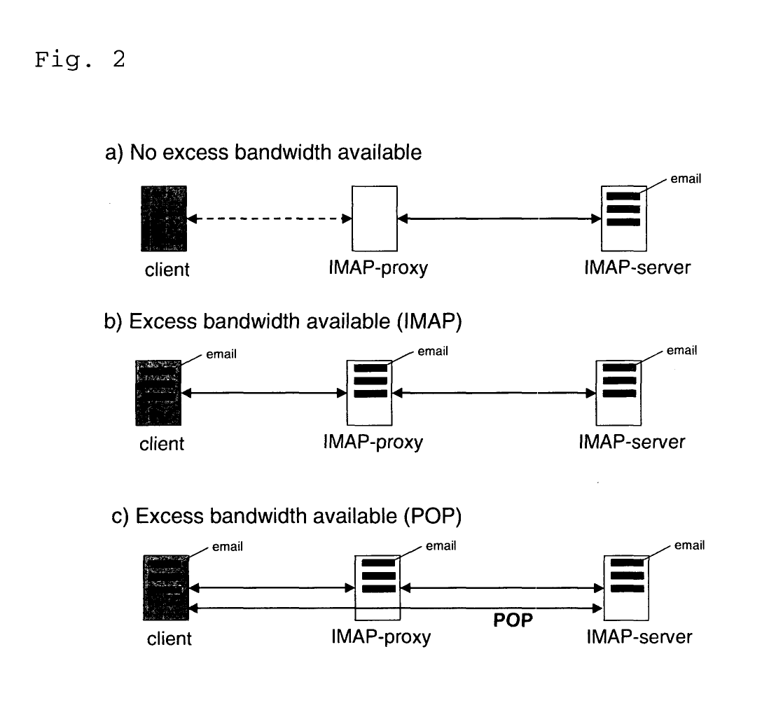

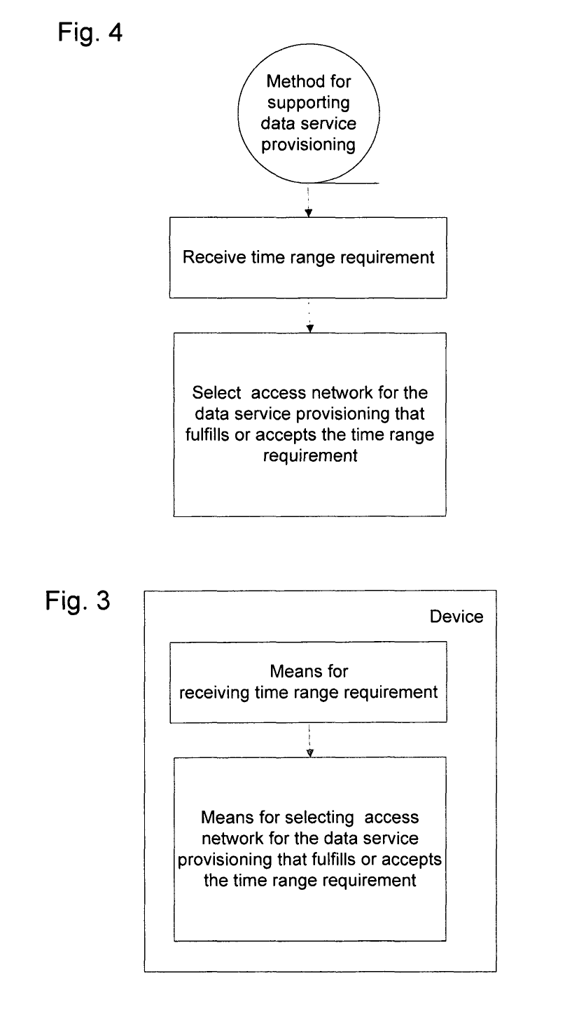

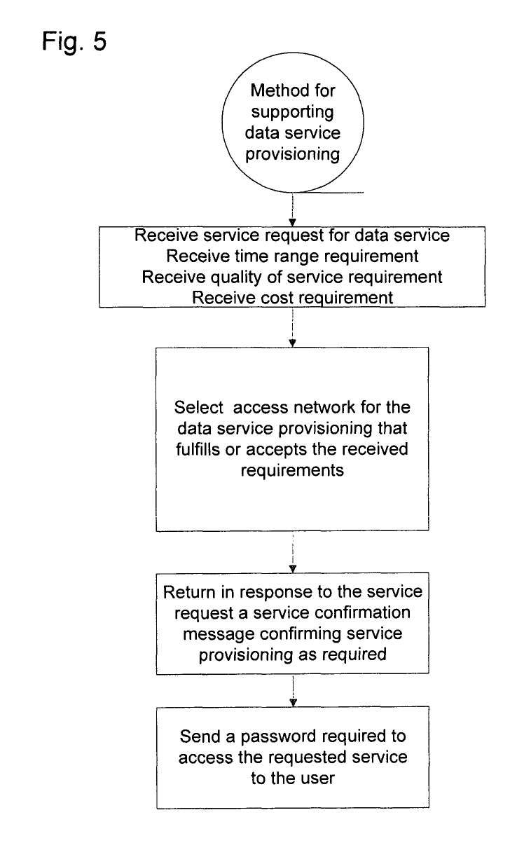

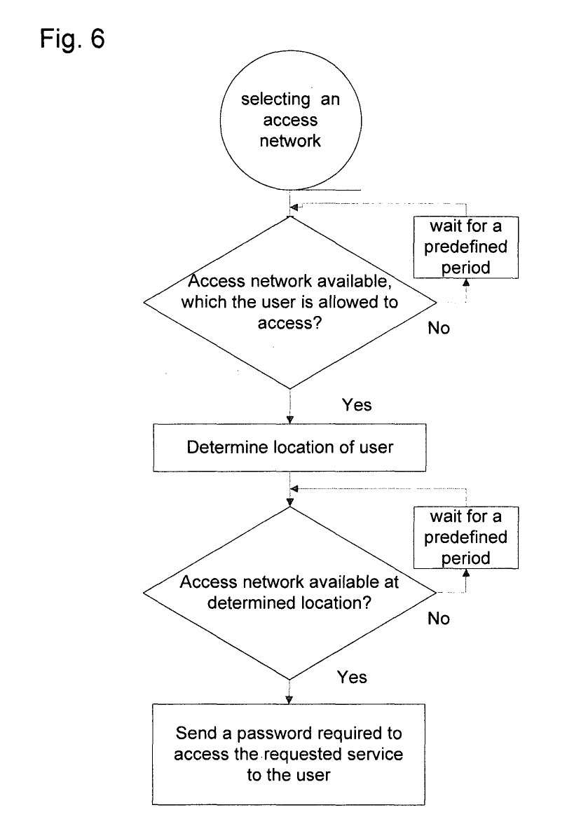

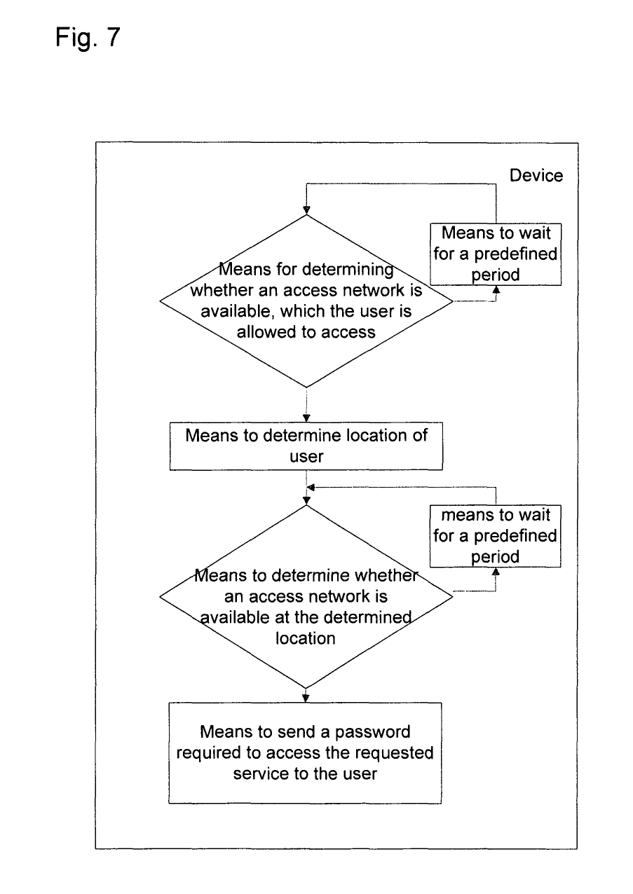

A further embodiment of the invention, which will be described in the following, is transparent for the subscriber, also called client in the following. The client is connected via GPRS towards a cooperate network. Here the client is connected to a proxy node (e.g. IMAP-proxy for email). This means that in the case that no excess bandwidth on the radio interface is available, the IMAP-proxy will signal to the IMAP-client that no new emails are available even so new emails are available on the IMAP server. When excess bandwidth is available the IMAP-proxy sends new emails to the IMAP-client and the IMAP-client will download the emails to the client via see FIGS. 2a, 2b and 2c.

In a further embodiment, the service to be provided is an Internet access. The Internet access is requested from the service center during a certain time for a certain payment. If the service center agrees with an access provider that such a service can be provided, the user-device is alerted, e.g. via SMS, optionally with password included. The user device indicates to the user that a connection is now possible, e.g. via LED or sound.

The invention offers the following advantage for the user. The user has to pay less for non real time data synchronization, because he will use excess capacities of the access networks that can be offered more inexpensive by the service providers or network/access operators. The invention provides an advantage for operators. They can sell also excess bandwidth in low traffic hours, e.g. during night. They are not violating their normal business, because the service is differentiated, e.g. the user can not determine at which exact point of time he gets access to the bandwidth.

The invention can be implemented in a device of a communication system, e.g. in a service centre of a communications network, a switching node, a proxy node, a radio access node, a node of an Intelligent Network or a Wireless LAN device or a WIMAX device, or a mobile terminal. The device may be constituted from a combination of a service centre of a communications network, a switching node, a proxy node, a radio access node, a node of an Intelligent Network or a Wireless LAN device or a WIMAX device, or a mobile terminal.

According to the invention, the device is adapted to perform the method for supporting a data service provisioning as described in the following.

The method comprises the steps of receiving a service request for the data service, receiving a time range requirement in relation to the requested data service, said time range requirement indicating a time range, in which the requested data service is to be provided, and selecting an access network that can provide the data service in the given time range.

Optionally the method comprises the steps of receiving a quality of service requirement in relation to the requested data service, said quality of service requirement indicating a required quality of service of the requested data service, and selecting an access network that can provide the data service while fulfilling the required quality of service.

Optionally the method comprises the steps of receiving a cost requirement in relation to the requested data service, said cost requirement indicating an upper cost limit or a price offer for the requested data service, and selecting an access network that can provide the data service while fulfilling the cost requirement.

Optionally the data service is a synchronization of data of an email account with a user device.

Optionally the data service is an internet access.

Optionally the service request originates from a user and the method comprises the step of sending an acceptance message to the user that the service request is accepted.

Optionally, the service request originates from a user, and the method comprises the step of sending a service confirmation message indicating that a provision of the requested data service is possible at present.

In one embodiment, the confirmation message is sent to the user, respectively to the user equipment. It is possible as well that the confirmation message is sent within the user equipment from one component to another component, eg. via a bus system.

Optionally, the confirmation message sent to the user, or to the user equipment respectively, comprises information about the selected access network.

In an alternative embodiment, the confirmation message is sent to the selected access network. In this case, the confirmation message may comprise at least one of a user information, the time range requirement as requested or as negotiated, or the cost requirement.

Optionally, the service request originates from a user, and the method comprises the step of sending a password to the user, said password being required to access the requested data service.

Optionally, the service request originates from a user, and the step of selecting an access network comprises the one-time or repeated step of determining an availability of at least one access network, which the user is allowed to access, and the access network is selected only from those access networks that are determined to be available for the user.

Optionally, the service request originates from a user, and the step of selecting an access network comprises the one-time steps or repeated steps of determining a location of the user and of determining, whether an access network is present at the determined location, wherein an access network that is not present at the location is not selected.

Optionally, the step of selecting an access network comprises the one-time or repeated step of negotiating with at least one access network a fee for the data service.

Optionally, the step of selecting an access network comprises determining for at least one access network by a look-up table comprising time information in relation to charging information of access networks, whether the service can be provided at a service fee not higher than the upper cost limit or the price offer.

Optionally the step of selecting an access network comprises the one-time steps or repeated steps of polling available access networks and requesting the data service as a best effort service, and of determining which of the polled access networks can provide the data service at first.

Optionally the step of selecting an access network comprises the one-time steps or repeated steps of broadcasting a request to access networks for the data service to be provided as a best effort service, and of determining which access network can provide the data service at first.

Optionally the method comprises the steps of receiving capacity information comprising information about unused bandwidth from at least one access network, storing or updating said capacity information in relation to the corresponding access network, and wherein an access network is selected by using the stored or updated capacity information.

Optionally the method comprises the one-time step or the repeated step of signalling to a user device that no new emails are available, unless an access network is selected.

Optionally, the time range identifies a dedicated time period in the future.

Optionally, the time range requirement comprises at least one of a start time of the time range or an end time of the time range. Optionally, the start time identifies a start time in the future.

Optionally, the time range requirement comprises a duration of the time range.

A further preferred embodiment of the invention refers to a computer program product directly loadable into an internal memory of a network node comprising software code portions for performing the steps of the above described method, when said product is run on a processor of said network node.

The invention has been described and illustrated beforehand by means of exemplary use cases implying particular requirements. Depending on the particular use case, a combination of features described beforehand with respect to different embodiments or use cases is feasible and may be useful at the discretion of the skilled person. Therefore, features of embodiments, examples and use cases might be combined in any way with each other. It shall be noted that the invention is neither limited to the described particular use cases, nor to the particular requirements, but that the scope of the invention is defined only by the following claims.

1-42. (canceled)

43. A device for supporting a data service provisioning, said device configured to:
receive a service request for the data service;
receive a time range requirement in relation to the requested data service, said time range requirement indicating a time range in which the requested data service is to be provided; and
select an access network that can provide the data service in the given time range.

44. The device according to claim 43, further configured to:
receive a quality of service requirement in relation to the requested data service, said quality of service requirement indicating a required quality of service of the requested data service;
select an access network that can provide the data service while fulfilling the required quality of service.

45. The device according to claim 43, further configured to:
receive a cost requirement in relation to the requested data service, said cost requirement indicating an upper cost limit or a price offer for the requested data service;
select an access network that can provide the data service while fulfilling the cost requirement.

46. The device according to claim 43, wherein the data service comprises a synchronization of data of an email account with a user device.

47. The device according to claim 43, wherein the data service comprises an internet access.

48. The device according to claim 43, wherein the service request originates from a user, the device further configured to send an acceptance message to the user that the service request is accepted.

49. The device according to claim 43, wherein the service request originates from a user, the device further configured to send a service confirmation message indicating that a provision of the requested data service is possible at present.

50. The device according to claim 43, wherein the service request originates from a user, the device further configured to send a password to the user, said password being required to access the requested data service.

51. The device according to claim 43, wherein the service request originates from a user, the device further configured to determine an availability of at least one access network available to the user, and wherein the device selects an access network only from those access networks determined to be available to the user.

52. The device according to claim 43, wherein the service request originates from a user, the device being further configured to determine a location of the user and whether an access network is present at the determined location, wherein the device selects an access network present at the determined location.

53. The device according to claim 43, further configured to negotiate with at least one access network a fee for the data service.

54. The device according to claim 45, further configured to determine, for at least one access network by a look-up table comprising time information in relation to charging information of access networks, whether the data service can be provided at a service fee not higher than the upper cost limit or the price offer.

55. The device according to claim 43, further configured to poll available access networks, request the data service as a best effort service, and determine which of the polled access networks can provide the data service at first.

56. The device according to claim 43, further configured to broadcast a request to access networks for the data service to be provided as a best effort service, and determine which access network can provide the data service at first.

57. The device according to claim 43, further configured to:
receive capacity information comprising information about unused bandwidth, from at least one access network; and
store or update said capacity information in relation to the corresponding access network;
wherein the device selects an access network based on the stored or updated capacity information.

58. The device according to claim 46, further configured to signal to a user device that no new emails are available unless the access network is selected.

59. The device according to claim 43, wherein said device comprises at least one of a service centre of a communications network, a switching node, a proxy node, a radio access node, a node of an Intelligent Network or a Wireless LAN device or a WIMAX device, and a mobile terminal.

60. The device according to claim 43, wherein the time range identifies a dedicated time period in the future.

61. The device according to claim 43, wherein the time range requirement comprises at least one of a start time of the time range and an end time of the time range.

62. The device according to claim 43, wherein the time range requirement comprises a duration of the time range.

63. The device according to claim 62, wherein the start time identifies a future start time.

64. A method for supporting a data service provisioning comprising:
receiving a service request for the data service;
receiving a time range requirement in relation to the requested data service, said time range requirement indicating a time range, in which the requested data service is to be provided; and
selecting an access network that can provide the data service in the given time range.

65. The method according to claim 64, further comprising:
receiving a quality of service requirement in relation to the requested data service, said quality of service requirement indicating a required quality of service of the requested data service;
wherein selecting an access network comprises selecting an access network that can provide the data service while fulfilling the required quality of service.

66. The method according to claim 64, further comprising:
receiving a cost requirement in relation to the requested data service, said cost requirement indicating an upper cost limit or a price offer for the requested data service;
wherein selecting an access network comprises selecting an access network that can provide the data service while fulfilling the cost requirement.

67. The method according to claim 64, wherein the data service comprises a synchronization of data of an email account with a user device.

68. The method according to claim 64, wherein the data service comprises an internet access.

69. The method according to claim 64, wherein the service request originates from a user, the method further comprising sending an acceptance message to the user that the service request is accepted.

70. The method according to claim 64, wherein the service request originates from a user, the method further comprising sending a service confirmation message indicating that a provision of the requested data service is possible at present.

71. The method according to claim 64, wherein the service request originates from a user, the method further comprising sending a password to the user, said password being required to access the requested data service.

72. The method according to claim 64, wherein the service request originates from a user, the method further comprising determining an availability of at least one access network available to the user, and wherein selecting an access network comprises selecting an access network only from those access networks determined to be available to the user.

73. The method according to claim 64, wherein the service request originates from a user, the method further comprising determining a location of the user, and determining whether an access network is present at the determined location, wherein selecting an access network comprises selecting an access network present at the determined location.

74. The method according to claim 64, further comprising negotiating a fee for the data service with at least one access network.

75. The method according to claim 64, further comprising determining, for at least one access network by a look-up table comprising time information in relation to charging information of access networks, whether the data service can be provided at a service fee not higher than the upper cost limit or the price offer.

76. The method according to claim 64, further comprising polling available access networks, requesting the data service as a best effort service, and determining which of the polled access networks can provide the data service at first.

77. The method according to claim 64, further comprising broadcasting a request to access networks for the data service to be provided as a best effort service, and determining which access network can provide the data service at first.

78. The method according to claim 64, further comprising:
receiving capacity information comprising information about unused bandwidth from at least one access network; and
storing or updating said capacity information in relation to the corresponding access network;
wherein selecting an access network comprises selecting an access network based on the stored or updated capacity information.

79. The method according to claim 67, further comprising signaling to a user device that no new emails are available unless the access network is selected.

80. The method according to claim 64, wherein the time range identifies a dedicated time period in the future.

81. The method according to claim 64, wherein the time range requirement comprises at least one of a start time of the time range and an end time of the time range.

82. The method according to claim 64, wherein the time range requirement comprises a duration of the time range.

83. The method according to claim 81, wherein the start time identifies a future start time.

84. A computer program product directly loadable into an internal memory of a network node comprising non-transient software code portions run on a processor of said network node, said software code portions adapted to:
receive a service request for the data service;
receive a time range requirement in relation to the requested data service, said time range requirement indicating a time range in which the requested data service is to be provided; and
select an access network that can provide the data service in the given time range.
